(19) United States
(12) Patent Application Publication
(10) Pub. No.: US 2006/0037484 A1
(43) Pub. Date: Feb. 23, 2006

(54) Container with sliding lid

(76) Inventors: Keith Antonio Dixon, Flanders, NJ (US); Allen McDowell, South Yorkshire (GB); Thomas Liebe, Thun (CH)

Correspondence Address: FITCH EVEN TABIN & FLANNERY, 120 S. LASALLE STREET, SUITE 1600, CHICAGO, IL, 60603-3406, US

(21) Appl. No.: 10/801,500

(22) Filed: Aug. 23, 2004

(51) Int. Cl. A47J 43/18

(52) U.S. Cl. 99/426

(57) ABSTRACT

A container for breath mints and the like includes a tray and lid. The lid may be retracted to define a dispensing slot of limited width for controlled dispensing. An internal shelf may be provided to facilitate dispensing. The lid and tray are configured to resist inelastic deformation during normal use.

### BACKGROUND OF THE INVENTION

1. Field of the Invention

The present invention pertains to containers for small sized contents such as breath mints and in particular to such containers having sliding lids.

2. Description of Related Art

A category of small packaging arrangements commonly referred to as sliding cover containers has been undergoing continued improvements. Containers of this type are typically carried about the person and may be used for small items such as mint confections. Such containers are preferably made from formed sheet metal and include a tray and a cover slidably engaged with one another.

Due to the relatively small size of the containers and the preferred relatively thin gage sheet metal material of which they are formed, the containers are susceptible to deformation in response to manual pressure applied by a user during opening and closing operations. It is been found that the cover, in particular is susceptible to such deformation. Should the cover become deformed, during use or otherwise, increased force may be necessary to open and close the container, requiring the user to apply even greater force, thus aggravating the problem.

Another problem with containers of this type is that the contents may be difficult to dispense in a controlled manner.

U.S. patent application Ser. No. 10/699,942, filed Nov. 3, 2003, the disclosure of which is incorporated by reference herein, discloses a sliding cover container for film strips that has proven to be commercially successful. There remains a need for further innovation with respect to sliding cover containers, and particularly with respect to sliding cover containers for small mints, candies and the like, in the form of tablets and the like.

### SUMMARY OF THE INVENTION

The invention provides a sliding cover container for food products such as small breath mints or other confectionary items which facilitates dispensing of the contents in a controlled manner. The container may have structural features which offer a user improved gripping of the container, especially during opening and closing operations. The cover is preferably strengthened to resist deformation by applied force, especially manual pressure exerted by user during a closing and opening operation.

The package assembly preferably includes a tray defining a product-receiving cavity for holding a plurality of food items, and a cover slidably mounted to the tray so as to be movable between a fully closed position and a partially open position for dispensing the food items. The tray has a pair of opposed ends and may define a shelf adjacent one end cooperating with the cover to position a small number of food items so that with minimal opening of the cover, the small number of food items may be dispensed from the package assembly.

The cover preferably includes at least one stop member engageable with the tray to limit the opening of the cover and prevent the cover from becoming accidentally disengaged from the tray. The tray may include an inclined ramp communicating with the shelf and assisting in directing the food items to the shelf.

The cover may include a depression which protrudes into the interior cavity of the package assembly. The protrusion may cooperate with the ramp and shelf to facilitate dispensing. The shelf may include a depression sized to retain a predetermined number of food items.

### BRIEF DESCRIPTION OF THE DRAWINGS

FIG. 1 is a perspective view of a container assembly according to principles of the present invention;

FIG. 2 is a side elevation thereof;

FIG. 3 is a perspective view thereof;

FIG. 4 is a perspective view of the tray portion thereof;

FIG. 5 is a perspective view of the tray filled with food product;

FIG. 6 is a top plan view of the container assembly;

FIG. 7 is a cross-section view taken along the line 7-7 of FIG. 6;

FIG. 8 is an end view of the container assembly;

FIG. 9 is another end view thereof;

FIG. 10 is a perspective view of another container assembly according to principles of the present invention;

FIG. 11 is a top plan view thereof;

FIG. 12 is an end view thereof;

FIG. 13 is an opposite end view thereof;

FIG. 14 is a side elevational view thereof;

FIG. 15 is a cross-sectional view taken along the line 15-15 of FIG. 11;

FIG. 16 is a perspective view showing the container assembly in an open position;

FIG. 17 is a bottom perspective view of the container assembly; and

FIG. 18 is a cross sectional view taken along the line 18-18 of FIG. 17.

FIG. 19 is a perspective view of an additional embodiment.

FIG. 20 is an end view of another additional embodiment.

### DETAILED DESCRIPTION OF PREFERRED EMBODIMENTS

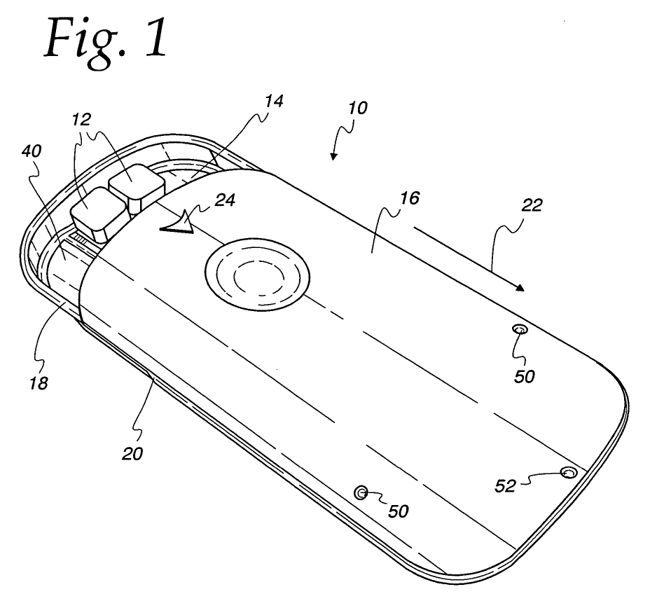

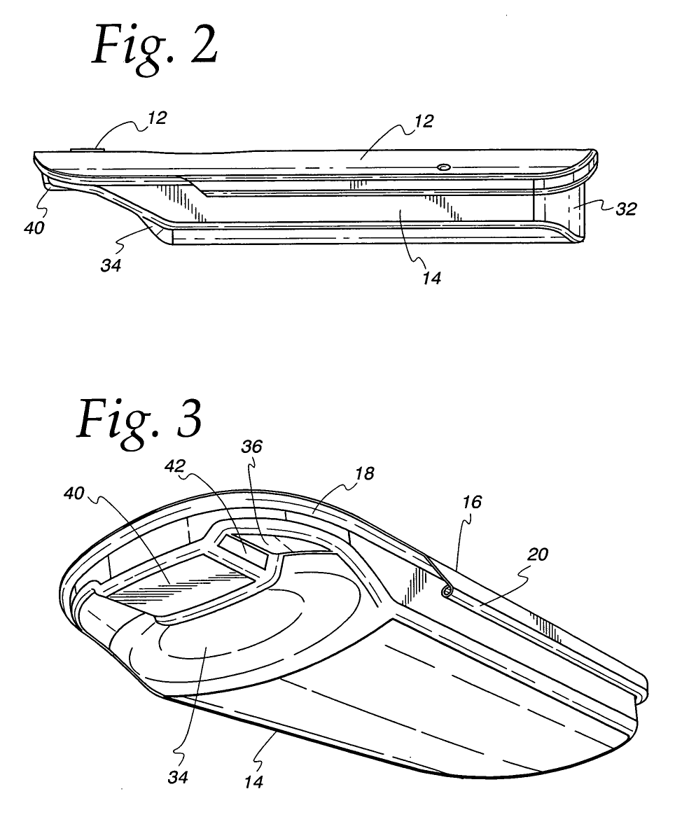

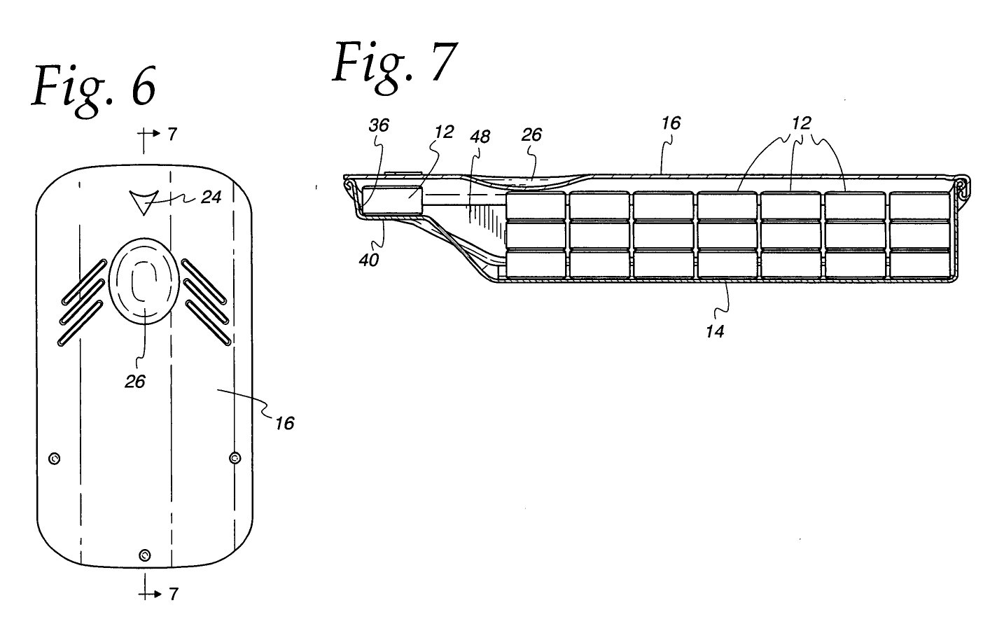

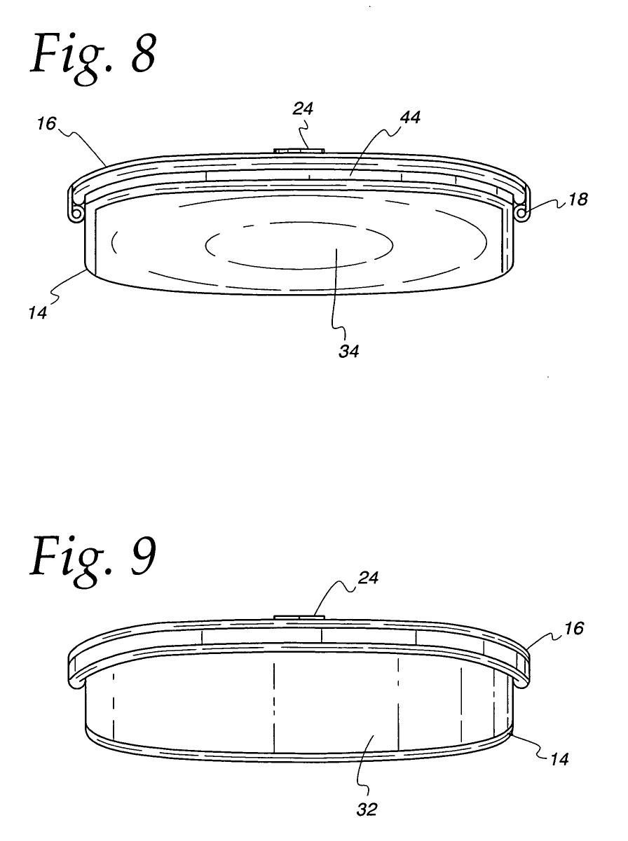

Referring now to the drawings and initially to FIGS. 1-9, a container assembly is generally indicated at 10. Container assembly 10 is generally of the type referred to as a sliding cover container, and may be used with food products such as mint tablets 12 shown in FIG. 5. Container assembly 10 generally includes a tray 14 and a cover 16 slidably mounted to the tray for movement between an open position, shown for example in FIG. 1, and a closed position, shown for example in FIG. 2. The tray and cover can be made of any suitable material but are preferably made out of 80-85 lb. tin coated steel.

Tray 14 has a continuous rolled edge 18 at its upper end. Cover 16 has a rolled edge 20 which cooperates with rolled edge 18 to retain the cover on the tray. If desired, the cover can be slid along the entire length of the tray, resulting in disengagement of the cover from the tray. This full extent of travel may be prevented or inhibited to avoid unintentional disengagement of the cover and tray members. Travel of the cover with respect to the tray is preferably limited in the manner indicated in FIG. 1 which shows the cover open (in the direction of arrow 22) in a dispense position. The direction of opening is indicated by arrowhead marker 24 which may preferably raised or embossed to facilitate application of opening or closing force to the lid.

A depression 26 is formed in the cover to assist the user in engaging the cover for opening and closing. In the embodiments shown herein, package assembly 10 is small enough to easily fit into the hand, having a length of about 74 mm, a width of about 40 mm and a height of approximately 14 mm. The depression 26 is accordingly sized to receive pressure from a user's thumb.

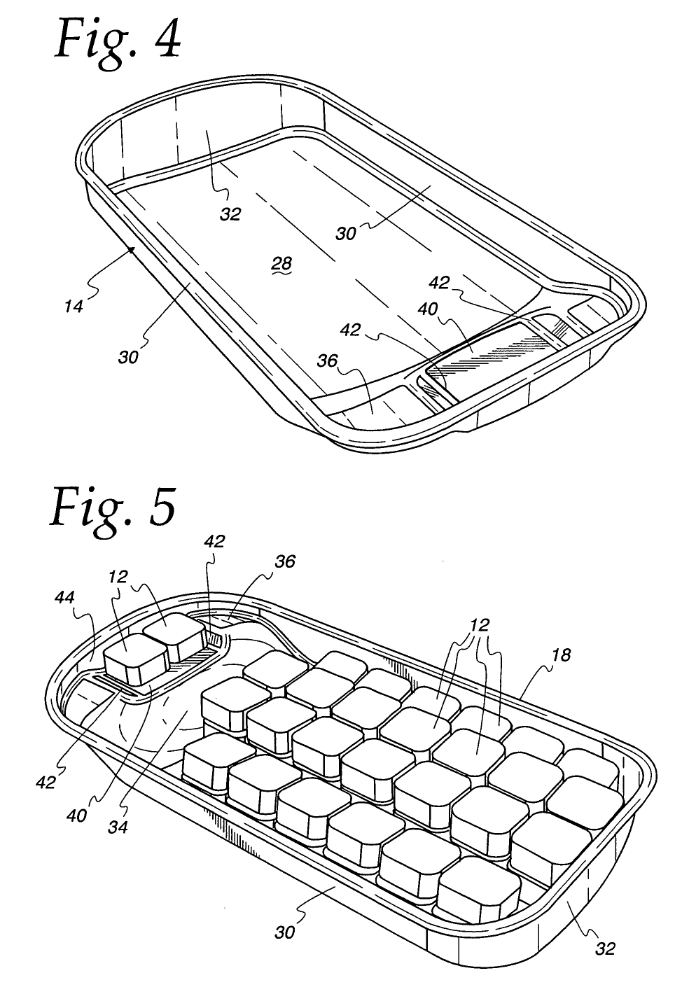

As shown in FIGS. 4 and 5, tray 14 includes a bottom wall 28, sidewalls 30 and an end wall 32. At the opposite end, tray 14 includes a ramp 34 extending from bottom wall 28 to an intermediate wall 36 spaced below the upper rolled edge 18. A dispensing shelf 40 is recessed within intermediate wall 36. Tablets 12 on shelf 40 are constrained by a pair of opposed sides 42 formed in intermediate wall 36 and a rear wall 44 terminated at its upper end by rolled edge 18. As indicated in FIG. 5, shelf 40 is dimensioned to receive two tablets. If desired, shelf 40 could be dimensioned to receive a different number of food items as desired.

Cover 16 has a dome shape with a concave surface facing toward the interior 48 of the container. A pair of laterally opposed stops 50 is formed in cover 16 and protrudes toward tray 14. Stops 50 are located immediately adjacent the tray sidewalls 30 and the upper rim portions 18 thereof. Upon opening, the stops 50 engage the upper edge of end wall 32 to provide stopping resistance against further opening of the cover. This allows a user to readily achieve the dispensing position indicated in FIG. 1, exposing the food items loaded onto shelf 40. By merely inverting the container assembly 10, the food items loaded onto shelf 40 are readily dispensed.

A locking member 52 is formed at one end of cover 16, adjacent stops 50. Locking member 52 engages the upper edge of end wall 32. As mentioned, the upper edge or rim of tray 14 forms a rolled rim, and locking member 52 readily cams over the rim surface. Preferably, locking member 52 is formed as a small indentation in cover 16. Stop members 50 are also conveniently formed in the same manner, although stop members 50 may extend a greater distance into the container interior to provide a stopping action rather than a snap action locking.

With reference to FIGS. 1, 5 and 7, food items contained in the interior cavity of tray 14 are enclosed by the domed cover 16, and are free to move about the interior of the closed container assembly. By tilting the container assembly in the direction of dispensing shelf 40, food items such as confectionary tablets are free to move toward shelf 40, so as to be loaded thereon in preparation for a dispensing action as described above with reference to FIG. 1. The ramp 34 assists in guiding the food items onto shelf 40 and preferably shelf 40 is smoothly blended with ramp 34 to assist in the loading operation.

The portions of intermediate wall 36 on each side of shelf 40 are recessed only a slight amount below rolled edge 18, so as to prevent food items from fitting between these portions of intermediate shelf 36 and cover 16 when the cover is closed. Accordingly, ramp 34, intermediate shelf 36 and the upstanding walls terminating in rolled edge 18 cooperate to guide food items onto shelf 40 when the container is tilted toward shelf 40.

Cover 16 includes an inwardly extending depression 26, provided to assist the user in opening the cover to the dispensing position shown in FIG. 1. Depression 26 may be dimensioned to extend in close proximity to shelf 40, to aid in maintaining the position of food items 12, once they are loaded onto shelf 40, and/or to aid in guiding the food items onto shelf 40.

The underside of tray 14 at the dispensing end of the container assembly includes the underside of shelf 40, which preferably, has a generally rectangular shape, and the underside of ramp 34. These surfaces cooperate with depression 26 to facilitate handling of the container assembly, particularly closing and opening the assembly. By grasping one end of the container assembly, a user can quickly and easily open and close the container.

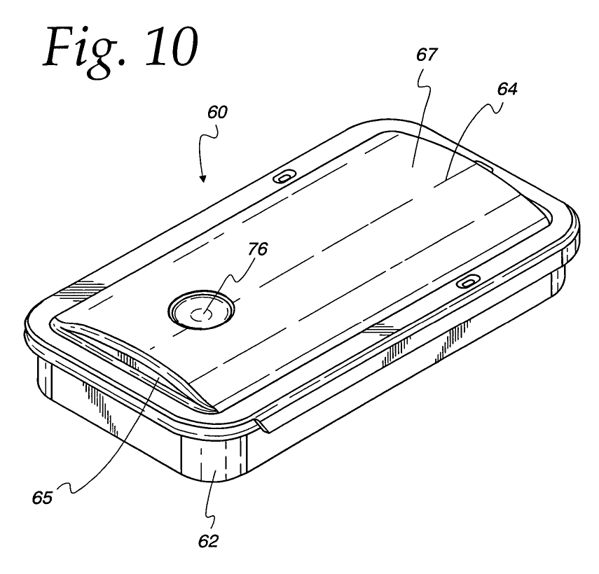

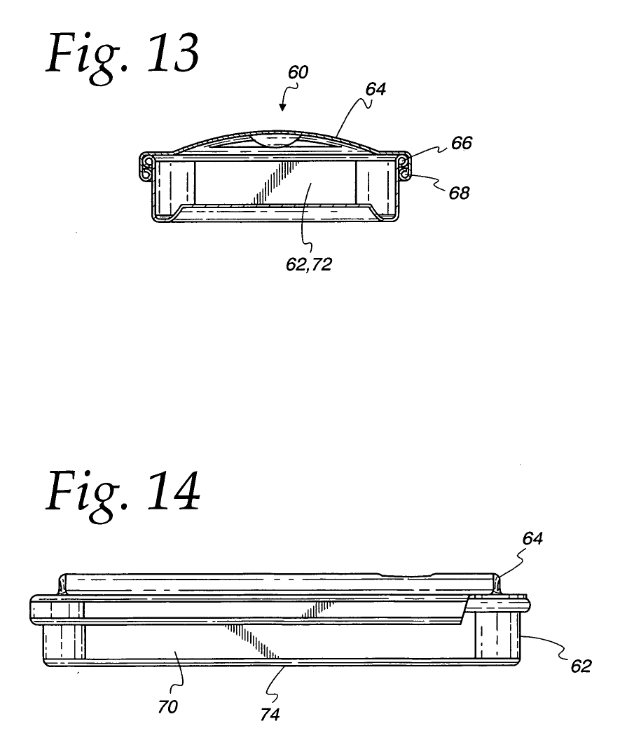

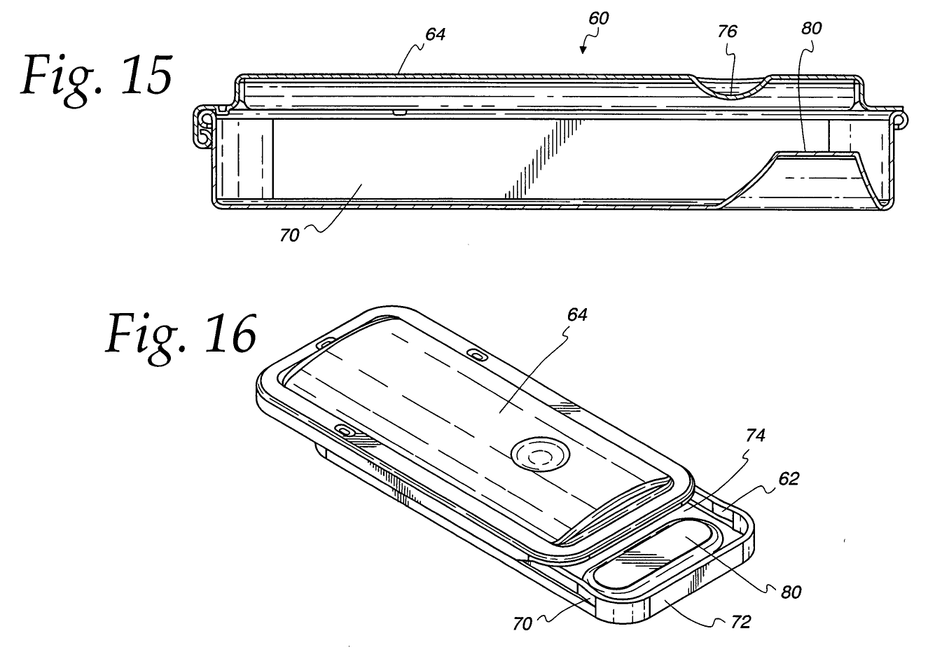

Referring now to FIGS. 10-18, a second container assembly is generally indicated at 60. The container assembly 60 also comprises a sliding cover container and preferably has the same general dimensions and is made of the same material as container assembly 10, described above. The container assembly 60 is comprised of a tray 62 and a cover 64. The tray and cover have rolled edges 66, 68 as can be seen for example in FIG. 13. As can be seen in the figures, tray 62 has upstanding sidewalls 70 and end walls 72 which have a generally rectangular configuration. The tray 62 has a generally flat bottom wall 74. The cover 64 has a domed shape similar to that of the preceding embodiment. A depression 76 is formed in one end of cover 64.

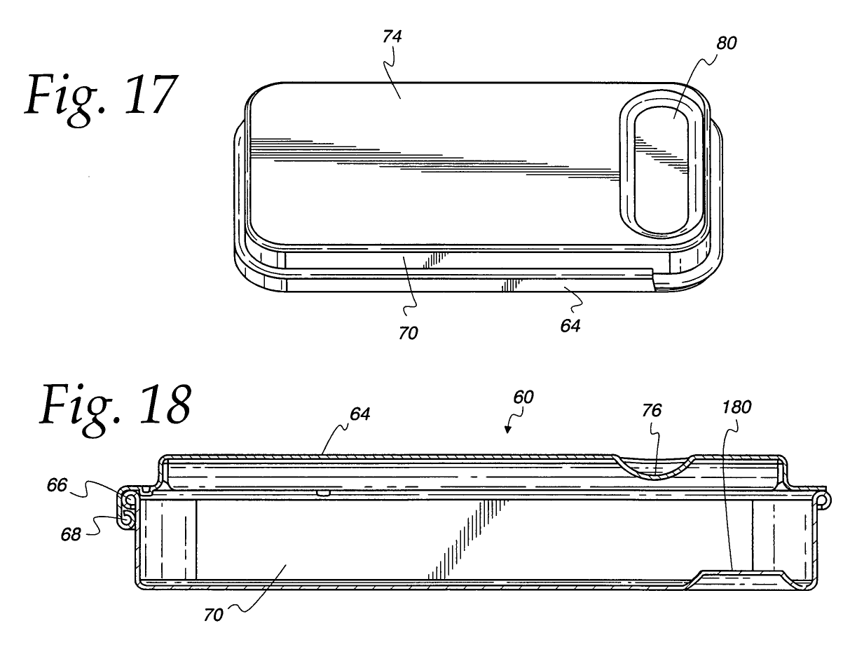

With reference to FIGS. 16 and 17, an indentation 80 is formed in bottom wall 74 and extends upwardly into the interior of the enclosed container. As can be seen for example in FIG. 17, indentation 80 has a generally oval shape with straight sides and semicircular or otherwise rounded ends. The indentation 80 also provides a raised shelf in the interior of the container that may facilitate dispending. The indentation 80 presents a substantial concave surface feature on the exterior of the tray. This concave feature provides a convenient gripping surface which cooperates with depression 76 to aid a user in opening and closing the container assembly. The indentation 80 also provides a raised shelf in the interior of the container that may facilitate dispensing. FIG. 18 shows another embodiment having an indentation 180 of a reduced dimension.

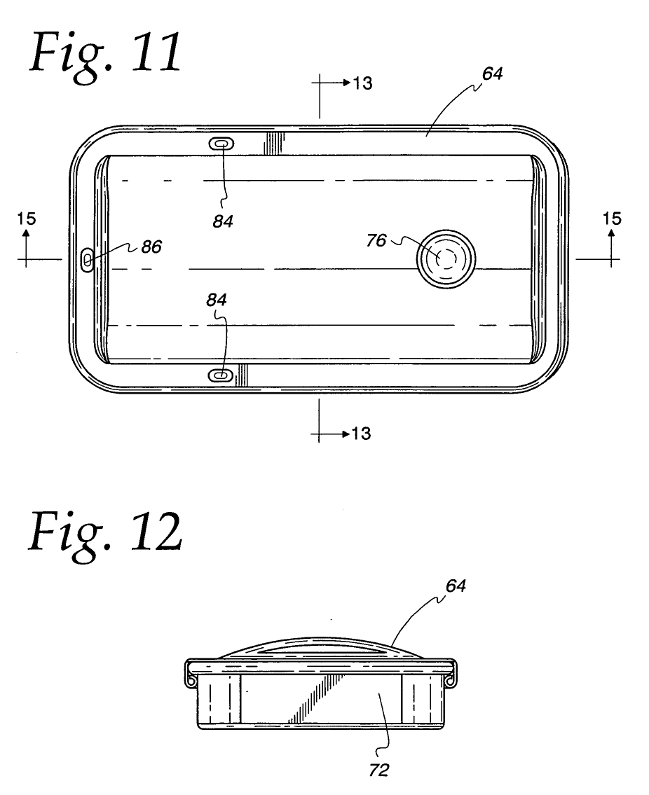

Referring to FIG. 11, a pair of stops 84 and a lock 86 are formed in cover 64. Preferably, the stops 84 and lock 86 are formed as nibs or depressions extending toward the container interior. As with the preceding embodiment, lock 86 cams over the upper edge of the tray end wall to provide a snap action locking feature. As with the preceding embodiment, stops 84 are located adjacent to the rolled upper edge of tray 62 and engage the tray end wall to provide a convenient tactile indication of the desired opening position for dispensing, similar to that described above with reference to FIG. 1. The stop members control opening to facilitate controlled dispensing of the product, and a locking nib provides a secure fit with a snap action when the cover is closed. In all embodiments described herein, the stops may be positioned to define a dispensing position for the lid wherein a dispensing slot is formed between an edge of the lid and the adjacent end wall of the tray. The width of the dispensing slot is preferably slightly greater than a horizontal dimension of one of the food items being dispensed, and is preferably less than twice that dimension, in order to facilitate controlled dispensing.

Each of the illustrated mints is generally square as viewed in plan, with rounded corners and a vertical dimension of about half its length and width. The tray is preferably dimensioned to hold 3 to 5 mints side-by-side.

In the embodiment shown in FIGS. 5 and 7, the mints are disposed in an array 4 across and 3 deep. The mints and container may, of course be sized differently in other embodiments. However, the dispensing slot preferably has a dimension greater than the length or width of each tablet, but less than 150% of that dimension to permit a single row of horizontally oriented mints to pass through the slot, while preventing additional mints from passing through at the same time.

Consumers tend to apply a significant amount of pressure on the container cover to assist with opening and closing. In certain instances, this pressure can cause the cover to bend, sometimes resulting in an inelastic deformation that impairs further operation. To address this problem, embossed or debossed shapes can be incorporated into the lid to increase its stiffness. For example, depressions have been added to the cover as pointed out above, and chevron-type bars or strips can be added to the cover adjacent to locations were a user applies manual pressure to open and close the container assembly. In addition, an arrowhead marker is provided as raised embossing and can be sized and shaped as desired to further strengthen the cover. Both the cover and the bottom of the tray may have shapes departing from flat planar configurations. In particular, dome configurations may be employed. As shown in FIG. 10, the cover may have a dome portion 67 with end walls 65 that are nearly vertical, e.g., within 10° of vertical, or at least within 45° of vertical. The curvature of the dome portion preferably accounts for at least one third of the lid height.

Before the steel is formed into a functional package, i.e. tray and cover, large blanks or flat sheets of metal may be printed using conventional techniques such as offset lithography printing. The printed blank may then be slit into a narrow strip containing several impressions. The metal strip may then be drawn or stamped into the desired shape with conventional cooperating die sets, in a shallow draw process, using conventional techniques. After drawing, raw edges may be curled or hemmed to enhance the strength of the cover and tray and to eliminate rough edges. Curling also adds to the shape retention of the cover and tray providing enhanced ease of operation on sliding the cover open and closed.

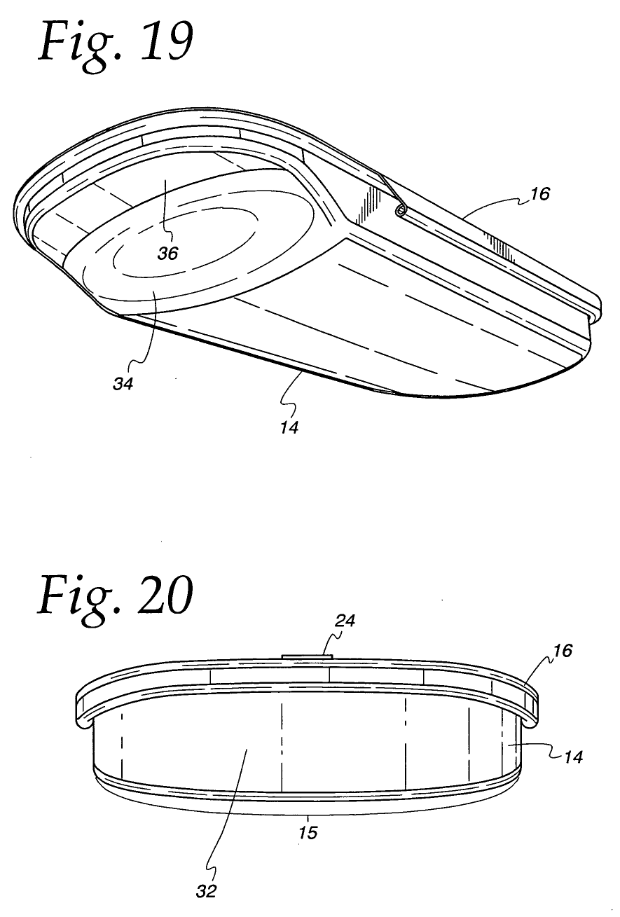

Referring now to FIG. 19, there is shown a tray is substantially identical to tray 14 shown in FIGS. 3-5 except that the central depression in intermediate wall 36 has been omitted.

FIG. 20 shows an end view of a container assembly generally resembling container assembly 10, wherein the bottom wall 15 of the tray 14 has increased curvature. This enhances the strength of the bottom wall, increasing its ability to resist deformation under applied manual pressure. Also, the concave shape increases the interior volume of the container assembly.

A curved bottom wall of this type may be employed in any of the embodiments discussed above.

We claim:

1. A package assembly for food products, comprising:
a tray defining a product-receiving cavity for receiving a plurality of food items; and
a cover slidably mounted to said tray so as to be movable between a fully closed position enclosing said cavity, and a partially open position for dispensing said food items;
said tray having a pair of opposed ends and defining a shelf adjacent one end to receive a limited number of said food items so that, with limited opening of said cover away from the first end of said tray, said limited number of said food items is free for extraction from said package assembly.

2. The package assembly of claim 1 wherein said cover is movable to an open position exposing a substantial portion of said cavity.

3. The package assembly of claim 2 wherein said cover comprises at least one stop member engageable with said tray to allow limited travel of said cover to be moved to said open position and to prevent disengagement of said cover from said tray.

4. The package assembly of claim 1 wherein said tray defines an inclined ramp communicating with said shelf.

5. The package assembly of claim 1 wherein said tray includes a bottom wall and an intermediate wall spaced above said bottom wall and said shelf is recessed within said intermediate wall.

6. The package assembly of claim 1 wherein said cover further includes a depression extending into said cavity.

7. The package assembly of claim 1 wherein said cover further includes a depression extending into said cavity, and cooperating with said tray to control movement of food items.

8. The package assembly of claim 1 wherein said tray and said cover are made from metal sheet material.

9. The package assembly of claim 1 wherein said cover and said tray include cooperating slide rails.

10. The package assembly of claim 1 wherein said shelf has a generally rectangular shape.

11. The package assembly of claim 1 wherein said shelf has a generally rectangular shape with opposed rounded ends.

12. A food product package assembly comprising:
a tray defining a product-receiving cavity and a plurality of food items therein, each of said food items having a horizontal dimension, a cover slidably mounted to said tray so as to be movable between a fully closed position enclosing said cavity, and a partially open position defining a slot for dispensing said food items so that, with limited opening of said cover away from the first end of said tray, a limited number of said food items may be dispensed in a controlled manner by gravity.

13. The package assembly of claim 12 wherein said tray includes an intermediate wall at an elevation above that of said bottom wall and a shelf recessed within said intermediate wall.

14. The package assembly of claim 13 wherein said tray defines an inclined ramp communicating with said shelf.

15. The package assembly of claim 14 wherein said shelf has a generally rectangular shape.

16. The package assembly of claim 15 wherein travel of said cover is limited to define a dispensing slot having a width greater than a horizontal dimension of one of said food items.

17. The package assembly of claim 16 wherein said cover comprises at least one stop member engageable with said tray to allow said cover to be moved to said open position and to prevent disengagement of said cover from said tray, and wherein said dispensing slot is less than twice said horizontal dimension of one of said food items.

18. The package assembly of claim 17 wherein said dispensing slot is greater than said horizontal dimension and is less than 150% thereof.

19. The package assembly of claim 18 wherein said cover further includes a depression extending into said cavity, and cooperating with said tray to guide said food items onto said shelf.

20. The package assembly of claim 19 wherein said tray and said cover are made from metal sheet material.

21. The package assembly of claim 20 wherein said cover and said tray include cooperating slide rails.

22. The package assembly of claim 21 wherein said shelf has a generally rectangular shape with opposed rounded ends.
